(19) United States
(12) Patent Application Publication
(10) Pub. No.: US 2018/0037054 A1
(43) Pub. Date: Feb. 8, 2018

(54) CROSS SPOKE NON-PNEUMATIC TIRE

(71) Applicants: Steven M. CRON, Simpsonville, SC (US); Timothy Brett RHYNE, Greenville, SC (US)

(72) Inventors: Steven M. CRON, Simpsonville, SC (US); Timothy Brett RHYNE, Greenville, SC (US)

(73) Assignee: Compagnie Generale des Etablissements Michelin, Clermont-Ferrand (FR)

(21) Appl. No.: 15/541,176

(22) PCT Filed: Dec. 30, 2015
(86) PCT No.: PCT/US2015/068114

§ 371 Date: Jun. 30, 2017

(51) Int. Cl. B60B 9/26; B60C 7/18; B60B 9/04

(52) U.S. Cl. CPC B60B 9/26; B60B 9/04; B60C 7/18; B60C 2007/146

(57) ABSTRACT

A non-pneumatic tire having a hub and a compliant outer band connected by multiple rows of connecting members, the connecting members of a given row of connecting members angled in a like direction and the predominant curvature of each connecting member resulting in the majority of the connecting member positioned toward a preferred intended direction of rotation of the tire.

### FIELD OF THE INVENTION

The subject matter of the present disclosure relates generally to tension-based non-pneumatic, structurally supported tires and wheels. More particularly, the invention relates to a tension-based non-pneumatic wheel having load supporting structural elements extending a portion of the width across the tire.

### BACKGROUND OF THE INVENTION

The pneumatic tire is the best known solution for compliance, comfort, mass, and rolling resistance; however, the pneumatic tire has disadvantages in complexity, the need for maintenance, and susceptibility to damage. A device that improves on pneumatic tire performance could, for example, provide more compliance, better control of stiffness, lower maintenance requirements, and resistance to damage.

Conventional solid tires, spring tires, and cushion tires, although lacking the need for maintenance and the susceptibility to damage of pneumatic tires, unfortunately lack its performance advantages. In particular, solid and cushion tires typically include a solid rim surrounded by a resilient material layer. These tires rely on compression of the ground-contacting portion of the resilient layer directly under the load for load support. These types of tires can be heavy and stiff and lack the shock absorbing capability of pneumatic tires.

Spring tires typically have a rigid wood, metal or plastic ring with springs or spring like elements connecting it to a hub. While the hub is thereby suspended by the springs, the inflexible ring has only a small contact area with the road, which offers essentially no compliance, and provides poor traction and steering control.

Non pneumatic tires having a compliant outer band and connecting elements linking the outer band and hub provide improved performance over spring tires. To date, however, non-pneumatic tires lack high speed dynamic stability so as to be suitable for high speed use in vehicles such as automobiles.

A non-pneumatic, compliant wheel having performance characteristics similar to those of pneumatic tires, while improving on its disadvantages, would overcome the various deficiencies in the art and would be a welcome improvement. Particularly a non-pneumatic, compliant wheel having multiple rows of connecting members extending from a hub to a compliant outer band in opposite directions that exhibit improved high speed dynamic stability would be particularly useful.

### SUMMARY OF THE INVENTION

Aspects and advantages of the invention will be set forth in part in the following description, or may be obvious from the description, or may be learned through practice of the invention.

In one embodiment the non-pneumatic tire includes a hub having a central axis and a hub width extending from a first lateral side of said hub to a second lateral side of the hub; a compliant outer band positioned radially outward from the hub; a plurality of connecting members having an inner end connected to the hub and an outer end connected to the compliant outer band; a first portion of the plurality of connecting members extending from the hub to the compliant outer band forming a first row of connecting members, each inner end and each outer end of each connecting member attached at points along said hub and said compliant outer band respectfully forming a positive angle to the radial direction; a second portion of the plurality of connecting members extending from the hub to the compliant outer band portion forming a second row of connecting members, each the inner end and each the outer end of each connecting member attached at points along the hub and the compliant outer band respectfully forming a negative angle to the radial direction, the first row of connecting members positioned laterally adjacent to the second row of connecting members; wherein each of the connecting members of the first row of connecting members possess a curvilinear shape, and each of the connecting members of the second row of connecting members possess a curvilinear shape, and the predominant curvature of each of the curvilinear shapes of the first and second connecting member sections extend in the same direction.

In another embodiment the non-pneumatic tire includes an inner band having a central axis and an inner band width extending from a first lateral side of the inner band to a second lateral side of the inner band; a compliant outer band positioned radially outward from the inner band; a plurality of connecting members having an inner end connected to the inner band and an outer end connected to the compliant outer band; a first portion of the plurality of connecting members extending from the inner band to the compliant outer band forming a first row of connecting members, each inner end and each outer end of each connecting member attached at points along the inner band and the compliant outer band respectfully forming a positive angle to the radial direction; a second portion of the plurality of connecting members extending from the inner band to the compliant outer band portion forming a second row of connecting members, each inner end and each outer end of each connecting member attached at points along the inner band and the compliant outer band respectfully forming a negative angle to the radial direction, the first row of connecting members positioned laterally adjacent to the second row of connecting members; wherein each of the connecting members of the first row of connecting members possess a curvilinear shape, and each of the connecting members of the second row of connecting members possess a curvilinear shape, and the predominant curvature of each of the curvilinear shapes of the first and second connecting member sections extend in the same direction.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of an embodiment of the invention attached to a hub.

FIG. 2 provides a side view of an embodiment of the invention.

FIG. 3 provides a perspective view of an embodiment of the invention with a portion of the compliant outer band including a portion of the tread and outer band removed.

FIG. 4 is an exploded assembly view of the major components of an embodiment of the invention.

FIG. 5 is a close-up partial side view of an embodiment of the invention including the outer compliant outer band in an unloaded state

FIG. 6 is a close-up partial side view of an embodiment of the invention including the outer compliant outer band in a loaded state against the ground.

FIG. 7 shows a close-up view of an embodiment of a single connecting element.

FIG. 8 shows a diagrammatic figure of a finite point on a connecting element and some of the Coriolis acceleration forces as the point passes over the contact patch.

The use of identical or similar reference numerals in different figures denotes identical or similar features.

### DETAILED DESCRIPTION OF THE INVENTION

The present invention provides for a non-pneumatic tire having improved high speed performance characteristics. For purposes of describing the invention, reference now will be made in detail to embodiments and/or methods of the invention, one or more examples of which are illustrated in or with the drawings. Each example is provided by way of explanation of the invention, not limitation of the invention. In fact, it will be apparent to those skilled in the art that various modifications and variations can be made in the present invention without departing from the scope or spirit of the invention. For instance, features or steps illustrated or described as part of one embodiment, can be used with another embodiment or steps to yield a still further embodiments or methods. Thus, it is intended that the present invention covers such modifications and variations as come within the scope of the appended claims and their equivalents.

The following terms are defined as follows for this disclosure:

“Axial direction” or the letter “A” in the figures refers to a direction parallel to the axis of rotation of for example, the hub or the wheel as it travels along a road surface, also referred to as the “transverse” direction of the tire.

“Radial direction” or the letter “R” in the figures refers to a direction that is orthogonal to the axial direction and extends in the same direction as any radius that extends orthogonally from the axial direction.

“Equatorial plane” means a plane that passes perpendicular to the axis of rotation and bisects the hub and/or wheel structure.

“Radial plane” means a plane that passes perpendicular to the equatorial plane and through the axis of rotation of the wheel.

“Web element straight line segment” is a straight line drawn along a plane which is parallel to the equatorial plane between a point of attachment of the web element to the inner interface band and a point of attachment of the web element to the outer interface band.

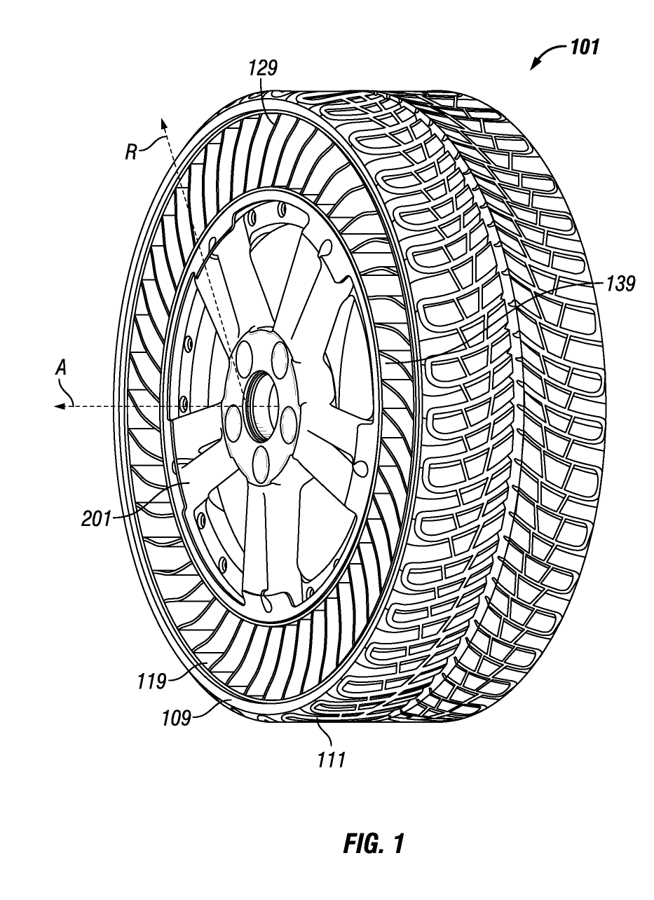

FIG. 1 provides a perspective view of a non-pneumatic wheel 101 which incorporates an embodiment of the invention. For illustration, this particular embodiment possesses a tread sculpture 111 along the outer surface of the outer band 109 which incorporates or is attached to an outer interface band 119. The outer interface band 119 is attached to an inner interface band 139 a plurality of connecting elements. The connecting elements, also referred to as “web elements” or simply “spokes,” here are shown as webs extending at an angle from the outer interface band 119 to the inner interface band 139. If a radial plane is positioned to extend through the point of connection of the inner interface band 138 with a web element 119, the web element straight line segment will be positioned at an angle relative to the radial plane. The larger the angle, the larger the deradialization of the web element. A hub 201 is shown here in FIG. 1 attached to the inner interface band.

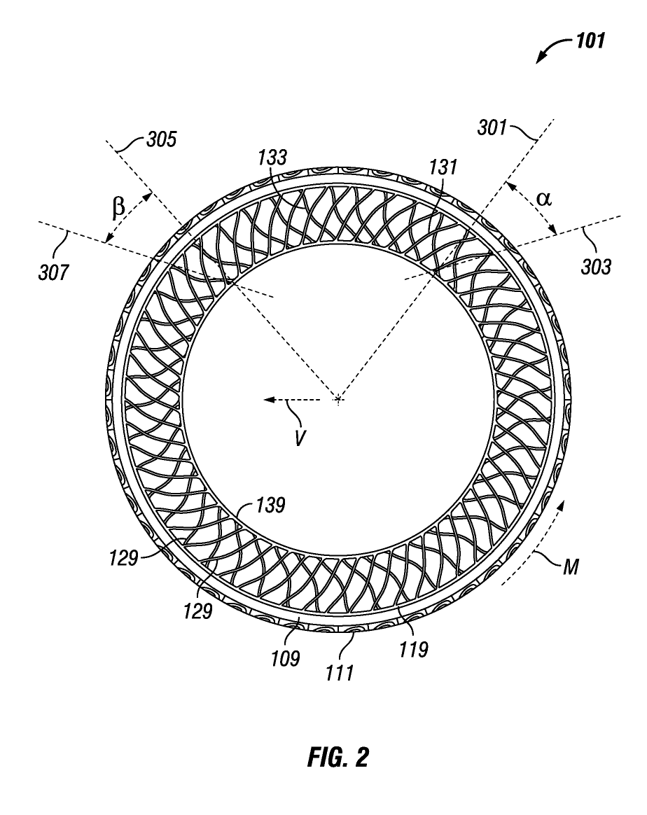

FIG. 2 provides a side view of the non-pneumatic wheel 101 of FIG. 1. Here the wheel hub is not shown. The wheel 101 possesses a plurality of connecting elements 129 connecting the outer interface band 119 to the inner interface band 139. In this particular embodiment, three rows of connecting elements 129 connect the hub to the compliant outer band 109, however, it should be understood that four rows, five rows, or another number of rows may be within the scope of the invention as well. A first row of a plurality of connecting elements 131 extending around and outward from the circumference of the inner interface band 139 are angled away from the direction of preferred rotation of the tire “M”, while a plurality of a second row of connecting elements 133, positioned axially inward from the first row of connecting elements and extending around and outward from the inner interface band 139, are angled toward the direction of preferred rotation of the tire. A third row of connecting elements 135, positioned on the other side of the second row of connecting elements are angled away from the direction of the preferred rotation of the tire, however cannot be seen in FIG. 2 because their location happens to correspond in this embodiment with the first row of connecting elements 131. When referring to being angled “toward” or “away from” the direction of rotation; “toward” the direction of rotation refers to, as shown here, where the connecting element 129 extends from a point on the inner interface band 139 and connects to the outer interface band 119 at a point along the outer interface band 119 that is on the side toward the local direction of motion relative to a point along a radial plane extending through the point of attachment of the connecting element 129 to the inner interface band 139.

Other embodiments may have the connecting elements of the first and third row of a plurality of connecting elements angled toward the direction of rotation, while the connecting elements of the second row of a plurality of connecting elements are angled away from the direction of rotation. In yet another embodiment, the connecting elements of at least one row of a plurality of connecting elements are angled away from the preferred direction of rotation of the wheel, and the connecting elements of at least one other row of a plurality of connecting elements are angled toward the preferred direction of rotation of the wheel.

As used herein, the “preferred direction of rotation” is a direction of rotation of the wheel in which it is to be rotated for general high speed use. For example, on a passenger vehicle, the vehicle is generally driven forward. This would be the “preferred direction” of the vehicle, and each wheel will have a corresponding “preferred direction of rotation.” The term “high speed” is used as it is generally understood in the automotive tire manufacturing industry and would include vehicles driving at speeds of 50 miles per hour or greater.

As described herein, the angle α of the first row of connecting elements, as measured from a radial plane 301 passing through the connection point of the element with the inner band and the web element straight line segment 303, will be said to be negative since they are angled away from the preferred direction of rotation of the tire “M”, while the angle β of the second row of connecting elements, as measured from a radial plane 305 passing through the connection point of the element with the inner band and the web element straight line segment 307, will be said to be positive since they are angled toward the direction of rotation of the tire. The angle of the third row of connecting elements in this particular embodiment is identical to the first, thus is negative. It is within the scope of the invention to have the first row angled in a positive direction, the second row in a negative direction and the third row in a positive direction. It is also within the scope of the invention, to have four rows of elements, where the first and fourth rows are negative, and the second and third rows are positive. It is also within the scope of the invention, to have four rows of elements, where the first and fourth rows are positive, and the second and third rows are negative. It is also within the scope of the invention to have a plurality of rows, where at least one row of connecting elements has a positive angle and at least one other row of connecting elements has a negative angle.

The greater number of rows of connecting elements allows for reduced lateral stiffness compared with a non-pneumatic tire of similar dimensions having a single row of connecting elements.

The angle of each connecting element within a given row may vary to some degree from element to element. For instance, within the first row, one connecting element may make an angle of +33 degrees, while connecting element immediately in front of or behind may make an angle of +35 degrees. Alternatively, all connecting elements a given row may have the same angle, say for example where the first row has all the connecting elements angled at +34 degrees. The angles of the connecting elements of the different rows of connecting elements may be different in their absolute values, or they may have shared values. For instance, the connecting elements of the second row may have an angle of −30 degrees while the connecting elements of the first and third row may have an angle of +34 degrees. Alternatively, the connecting elements of all the rows may have the same absolute angle value such as where the connecting elements of the first and third rows have an angle of −33 degrees and the connecting elements of second row has an angle of +33 degrees. The angle, as described above, of a connecting element 129 is measured when the tire is not under any loads, as the angle may change slightly when the tire is under load, and may vary depending upon its position around the tire.

Having multiple rows of connecting elements allows for the positioning of the connecting elements 129 at greater angles than what could be achieved on a wheel with a similarly sized hub and outer compliant outer band. The increased angle reduces the amount of tension the web elements undergo for a given torque by orienting the web elements closer to the direction of the rotation of the tire. The increased angle also allows for longer connecting elements to be used to connect the outer interface band and inner interface band and thus the length of the connecting elements are not limited to the radial distance between the hub and ring. Longer connecting elements reduce the connecting element's strain energy density compared to a connecting element having a shallower angle to a radial orientation. Given that fatigue cracks are driven by strain energy density and that peak spoke strain energy density in a spoke is inversely proportional to spoke length to the third power, durability is improved by longer angled spokes.

In the embodiment shown about half of the spokes increase in tension while the remaining half reduces tension when the tire is undergoing braking or deceleration forces. This reduces oscillations due to braking torque that can be generated from vertical stiffening of a non-pneumatic tire having more radially oriented connecting elements.

The multiple rows of connecting elements enable for increased torsional stiffness of the wheel which reduces contact patch movement under vehicle acceleration and deceleration. This increased torsional stiffness reduces the fore and aft movement of the contact patch when acceleration and braking forces are applied to the wheel by the vehicle. Such a reduction in contact patch movement reduces changes of the effective mechanical trail of the suspension and can improve overall vehicle handling.

The greater angle of each connecting elements enabled by having multiple rows of connecting elements with the elements of at least one row of connecting elements having a negative angle and the elements of at least one other row of connecting elements having a positive reduces the bottom loading upon the connecting elements traveling through the contact patch, reducing the ability of the connecting elements to transmit road noise.

The number of connecting members 129 in each row of connecting members may vary between the rows. For instance, in the embodiment shown, there are 58 connecting members in the first row of connecting members, 44 connecting members in the second row of connecting members, and 58 connecting members in the third row of connecting members. An alternative embodiments may have a different number of connecting elements per row than the embodiment shown here, and/or may have the same number of connecting elements in each row. Having a fewer number of connecting elements in the second row allows for greater spacing between the connecting elements.

Having a different number of spokes in different rows, the frequency associated with the passing of the spokes through the contact patch is divided into multiple harmonics, and can further reduce the energy content of each frequency relative to a single spoke passing frequency of a non-pneumatic tire having only one row of connecting members arranged transversely across the tire.

The angle of each connecting element may be chosen depending upon the characteristics desired. Preferably, however, the angle is limited by the spacing between each connecting element such that the angle and spacing chosen such that, under the normal anticipated loads for a given tire, the connecting elements do not touch or rub one another as they travel through the contact patch. While a larger angle has certain advantages, the larger the angle each connecting element makes, the less number of spokes can be placed within that particular row of spokes due to geometrical constraints which increases the portion of the total load each connecting element must carry.

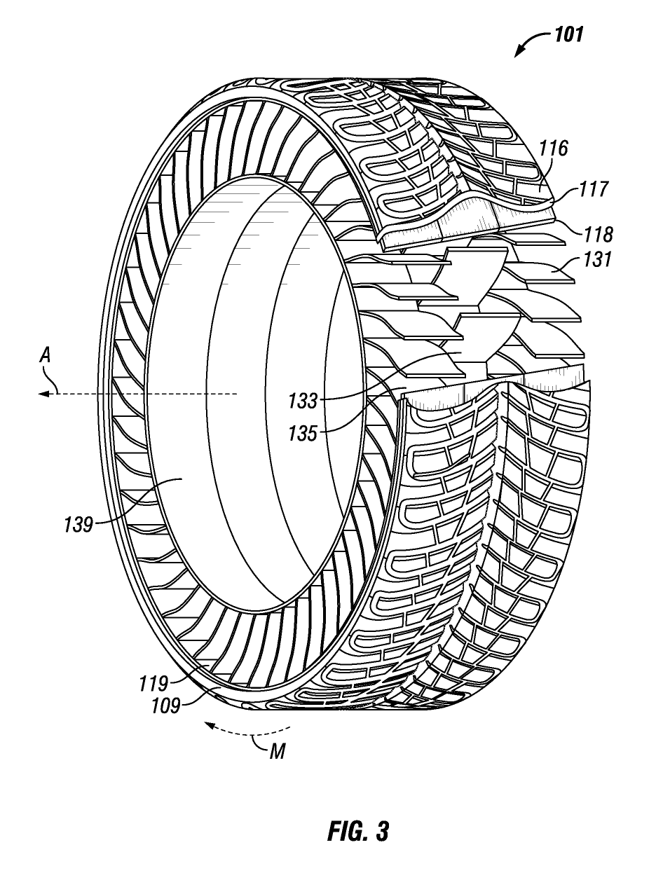

FIG. 3 shows a perspective view of an embodiment of the invention where a portion of the compliant outer band 109 (including the outer interface band) has been removed to show the first row of connecting members 131, the second row of connecting members 133 and the third row of connecting members 135. In this embodiment, the second row of connecting members have a width in the axial direction which is wider than the width of the connecting members of the first or second row of connecting members. The connecting band 109 may be comprised of a shear band 115 having a first reinforcement membrane 116 and a second reinforcement membrane 118 which are separated by a shear layer 117.

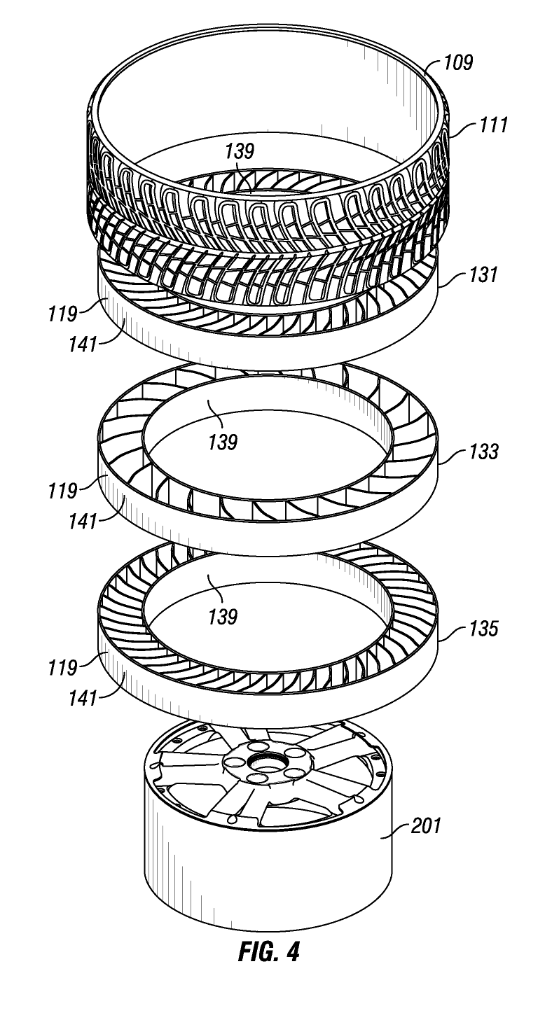

FIG. 4 shows a perspective assembly view of the compliant outer band 109, the first row of connecting elements 131, the second row of connecting elements 133, the third row of connecting elements 135, and a hub 201. When assembled radially outward surface 141 of the outer interface band 119 of each of the rows of connecting elements 131, 133, 135 is bound to the radially inner surface of the compliant outer band 109 and the radially inward surface 143 of the inner interface band 139 of each of the rows of connecting elements 131, 133, 135 is bound to the radially outer surface of the hub 201. The binding of the rows of connecting elements to the tread surface can be made by any suitable method including by using an adhesive to bind the components together.

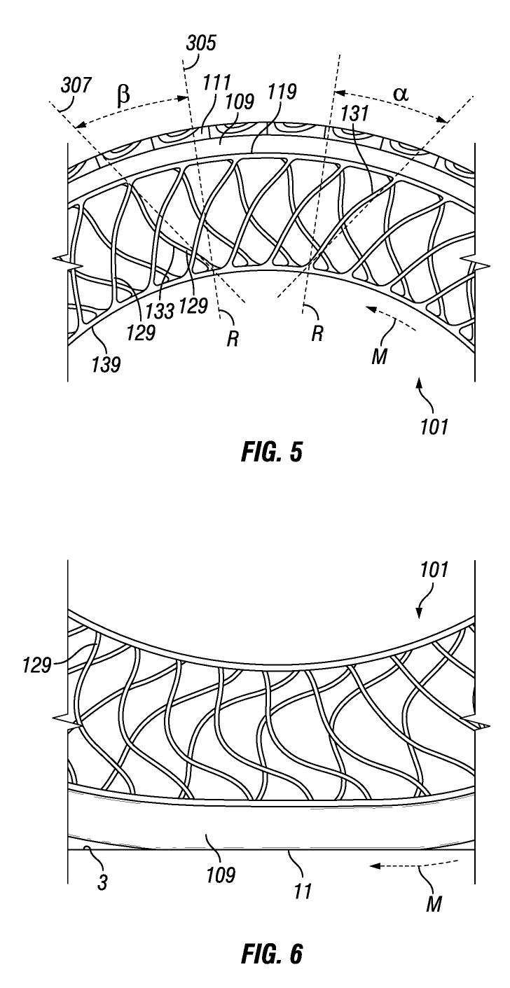

FIG. 5 shows a partial side view of the tire 101 showing the inner interface band 139, connecting elements 129, outer interface band 119, and the compliant outer band 109 and tread sculpture 111. The first row of connecting elements 131 is shown angled toward the right of the figure forming a negative angle α as defined above. The second row of connecting elements 133 is shown angled toward the left of the figure forming a positive angle β as defined above. The direction of rotation, “M,” is shown for the tire 101.

When a load is applied to the hub of the tire, such as when the tire is subject to the weight of the vehicle and vehicle contents and occupants, the compliant outer band 109 is pressed against and conforms to the ground surface 3 as shown in the partial view of the tire 101 in FIG. 6. The outline of the area of contact is generally referred to as the contact patch 11, and may include any voids, if present, between the sculptural elements of the tread that do not contact the ground surface. The tread band is closer to the hub at the location of the contact patch and the connecting elements 129 tend to buckle and the web element straight line segments become shorter. As the tire rolls, the various connecting elements 129 pass into and out of the contact patch. The curved shape of each of the connecting elements predisposes each connecting element to buckle in a predetermined direction and manner as they pass through the contact patch. Other forces also act upon the web elements to induce or resist buckling, such as the change in angle of the compliant outer band 109 as it enters the contact patch. This change in angle causes a moment in the connecting element 129, clockwise as shown, which acts to resist buckling of the connecting element. As the speed of the tire increases, other forces become greater, in particular, it is thought that a Coriolis acceleration causes a force to act upon the connecting element as it enters the contact patch in the direction of rotation of the tire. This force acting upon the connecting element 129 as it enters the contact patch pushes the connecting element 129 to the left, as drawn, in the direction of rotation of the tire and in the opposite direction the vehicle is traveling.

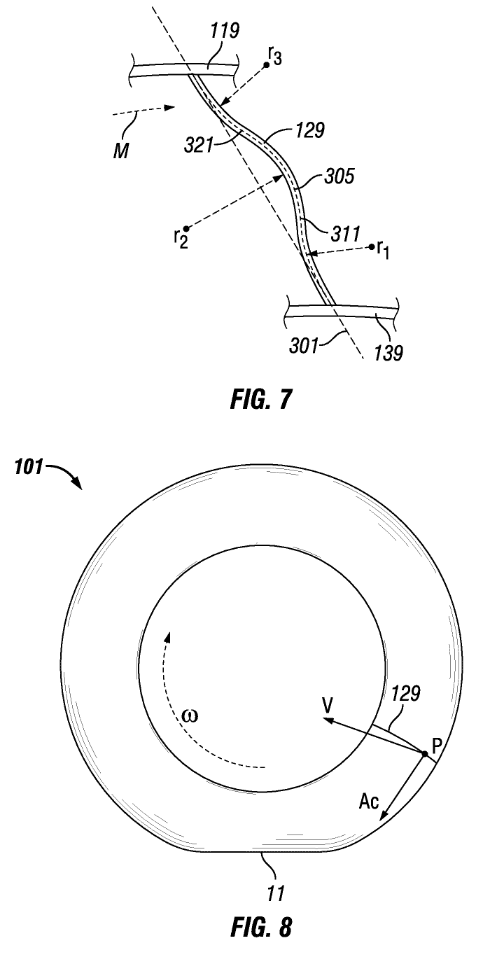

As shown in FIG. 7, in the present embodiment, each connecting element possesses a first curve in a first direction having a radius r₁, a first inflection point 311, a second curve in a second direction having a radius r2, a second inflection point 321, and a third curve in the first direction having a radius r3, as measured by a centerline 305 drawn through the middle of the connecting element's thickness. The combined total curvature, or predominant curvature, of the connecting element causes a majority of the connecting element's volume, and therefore also mass, to reside on one side of the connecting element's straight line segment 301. This predisposes the connecting element to buckle toward the opposite side of the straight line segment from which a majority of the connecting element's volume resides.

As the wheel rotates, the connecting elements roll in and out of the contact patch, and in buckling of each connecting element occurs as a result of the summation of forces acting upon the connecting element. Under load at relatively low speeds, say, for example 10 kilometers per hour, with a connecting element having a curvature as shown, each of the web elements buckling toward the side of the connecting element's straight line segment 301 on which there is less volume. As the speed increases other forces and moments become greater and the connecting element will buckle as a result of a sum of the forces and moments acting upon it. Each of the connecting elements of the present invention are arranged to be predisposed to buckle when moving through the contact patch in the direction that is away from the direction of rotation of the wheel. That is, the connecting elements of each row of connecting elements all possess a predominant curvature that is in the same direction, and that direction causes a lateral movement of the connecting element toward the direction of rotation of the wheel. At higher speeds, the connecting element moves toward the center of rotation of the wheel and the conservation of angular momentum induces a force directed generally in the same direction as the rotation of the wheel, reinforcing the natural buckling tendencies of the predominant curvature of the connecting element. The web elements predominant curvature in the direction away from direction of the rotation of the tire results in less noise, less vibrations, and reduced fatigue of the connecting members of the wheel.

FIG. 8 diagrammatically shows a wheel 101 and a web element 129 to explain the Coriolis acceleration upon a representative point “P” of a web element 129 as it enters the contact patch 11. Assuming point P has mass, as point P begins to enter the contact patch 11, the point experiences a velocity “V” in the rotating reference frame of the wheel 101 as shown. Assuming “V” and “w” to be vectors in the rotating reference frame of the wheel 101, then the Coriolis acceleration “Ac” in the rotating reference frame is given by the well-known expression:

Ac=−2ω×V (eqn. 1)

Where the “x” denotes a vector cross product. Point P, as part of the connecting element which is attached to the wheel is restrained from accelerating in the direction of rotation by a deceleration force in the opposite direction. This deceleration force urges the web element in the direction of rotation as the web element enters the contact patch. The Corriolis acceleration has the effect of urging the buckling of the connecting element in the same direction that the predominant curvature urges the connecting element to buckle, stabilizing the web element at high speed as it enters the contact patch. At the exit of contact, point P is experiences deceleration due to the Coriolis effect and the connecting element enters back into a state of tension.

The above models the Coriolis acceleration and forces on a finite portion “P” of the connecting element at a given distance along the connecting element. It should be understood that the Coriolis effect is a result of the radial movement of the mass of the connecting element. It should be understood that the Coriolis acceleration is greater for portions of the connecting element that undergo greater radial movement, such as near the compliant outer band, and less for portions of the connecting element that undergo less radial movement, such as near the inner interface band.

While the present subject matter has been described in detail with respect to specific embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A non-pneumatic tire comprising:
a hub having a central axis and a hub width extending from a first lateral side of said hub to a second lateral side of said hub;
a compliant outer band positioned radially outward from said hub;
a plurality of connecting members having an inner end connected to said hub and an outer end connected to said compliant outer band
a first portion of said plurality of connecting members extending from said hub to said compliant outer band forming a first row of connecting members, each said inner end of said first row connecting member attached to said hub and each said outer end of each of said first row connecting member attached to said compliant outer band, a straight line segment extending between said inner end and said outer end of said first row connecting member forming a first angle relative to the radial direction;
a second portion of said plurality of connecting members extending from said hub to said compliant outer band portion forming a second row of connecting members, each said inner end of said second row connecting member attached to said hub and each said outer end of said second row connecting member attached to said compliant outer band, a straight line segment extending between said inner end and said outer end of said second row connecting member forming a second angle relative to the radial direction, wherein said first angle and said second angle are in opposite directions and said first row of connecting members are positioned laterally adjacent to said second row of connecting members;
wherein each of said connecting members of said first row of connecting members possess a curvilinear shape, and each of said connecting members of said second row of connecting members possess a curvilinear shape, and the predominant curvature of each of said curvilinear shapes of said first and second rows connecting members extend in the same direction.

2. The non-pneumatic tire of claim 1 wherein:
said tire possesses three rows of connecting members.

3. The non-pneumatic tire of claim 2 wherein:
said second connecting member row is positioned axially adjacent to said first row and said third row of connecting members;
each said inner end of said third row connecting member are attached to said hub and each said outer end of each of said third row connecting member are attached to said compliant outer band, a straight line segment extending between said inner end and said outer end of said third row connecting member forming said third angle relative to the radial direction;
wherein said third angle and said second angle are in opposite directions and said first angle and said third angle are in the same direction and each of said connecting members of said third row of connecting members possess a curvilinear shape, and the predominant curvature of each of said curvilinear shapes of said first, second and third rows of connecting members extend in the same direction.

4. The non-pneumatic tire of claim 3 wherein said connecting members of said second row of connecting members are wider than the connecting members of said first row of connecting members and said connecting members of said second row of connecting members are wider than the connecting members of said third row of connecting members.

5. The non-pneumatic tire of any of the above claims wherein each of the connecting members are only connected to said hub at said inner end and said compliant outer band at said outer end.

6. The non-pneumatic tire of any of the above claims wherein the angle of the connecting member is measured by the angular difference between a straight line segment of the connecting member and a line in the radial direction passing through the connection point of the connecting member with said hub, wherein said angle is said to be positive if the straight line segment is angled toward a preferred direction of rotation of the tire, or negative if it is angled away from said preferred direction of rotation of the tire and said first angle is negative and said second angle is positive.

7. The non-pneumatic tire of any of claims 1-5 above wherein the angle of the connecting member is measured by the angular difference between a straight line segment of the connecting member and a line in the radial direction passing through the connection point of the connecting member with said hub, wherein said angle is said to be positive if the straight line segment is angled toward a preferred direction of rotation of the tire, or negative if it is angled away from said preferred direction of rotation of the tire and said first angle is positive and said second angle is negative.

8. The non-pneumatic tire of any of the above claims wherein said straight line segment is a straight line passing through the connection of the connecting member with said hub and the connection of the connecting member with said compliant outer band.

9. The non-pneumatic tire of any of the above claims wherein the direction of which said predominant curvature of said connecting member is said to extend is the in the direction from said straight line segment of said connecting member on which the majority of the volume of the connecting member resides.

10. The non-pneumatic tire of any of the above claims wherein the direction of which said predominant curvature of said connecting member is said to extend is the in the direction from said straight line segment of said connecting member on which the majority of the mass of the connecting member resides.

11. The non-pneumatic tire of claim 1 wherein:
said tire possesses four rows of connecting members.

12. The non-pneumatic tire of claim 1 wherein:
said tire possesses five rows of connecting members.

13. The non-pneumatic tire of claim 1 wherein:
said tire possesses six rows of connecting members.
